(19) United States
(12) Patent Application Publication
(10) Pub. No.: US 2002/0087624 A1
(43) Pub. Date: Jul. 4, 2002

(54) Method and device for temporarily storing data

(75) Inventor: Frank Liebenow, Dakota Dunes, SD (US)

Correspondence Address: LYON & LYON LLP, 633 WEST FIFTH STREET, SUITE 4700, LOS ANGELES, CA, 90071, US

(73) Assignee: Gateway, Inc.

(21) Appl. No.: 09/752,666

(22) Filed: Dec. 28, 2000

(51) Int. Cl. G06F 15/16; G09G 5/00

(52) U.S. Cl. 709/203; 345/745

(57) ABSTRACT

A method and device for temporarily storing data received from a server in a distributed system. A minimum storage time for the stored data is designated by a user, and the stored data may be deleted only after the specified storage time ends. The stored data may be then retrieved during the storage time without the client being in communication with the server.

### BACKGROUND OF THE INVENTION

1. Field of the Invention

The present invention relates generally to data storage, and more particularly to storing data for a specified minimum length of time.

2. Related Art

In distributed systems such as local area networks (“LANs”), wide area networks (“WANs”), and the World Wide Web (“Web”), data retrieved from a server may be temporarily stored in, e.g., a cache memory, to save download time of data and thus allow faster subsequent retrieval of the data by accessing the data cache rather than retrieving it again from the Internet.

Conventional cache storage suffers from significant shortcomings. Cached data is deleted on a first-in/first-out basis when the space allocated for caching is full. Accordingly, previously cached data may be discarded to enable caching of new data. The user cannot predict with certainty that any particular data cached in the past will be available from the cache at any particular time in the future. Permanent storage may help, but can rapidly deplete storage space. Further, data stored in cache with conventional methods is not easily identifiable even if retained. The problems are particularly true for devices that may have limited data storage capacity, e.g., thin clients, Internet appliances, and dedicated computers. Examples of such devices include Web-enabled personal digital assistants (“PDAs”) and mobile telephones.

A need therefore exists to provide that particular data may be temporarily stored for a user-defined time period, and that the stored data may be easily identifiable for retrieval, without undue build-up over time of stored data.

### SUMMARY OF THE INVENTION

The present invention solves the above problems by providing a system and method in which a client receives data from a server in a distributed system, designates that the received data be temporarily stored, specifies a minimum length of time during which the received data is to be temporarily stored, and temporarily stores the received data or a portion thereof. The present invention further provides a client configured to carry out the method.

A user may specify the type of data to be temporarily stored and the amount of time the data is to be stored. The data may be stored in a special cache. Data in the special cache would have a user-specified deletion deadline, such that the data may only be deleted after the deletion deadline passes. Prior to passage of the deletion deadline, the data would not be subject to conventional first-in/first-out deletion. The user may also view a list of the specially cached files, and may have the option of modifying the properties of the files.

One variation of the present invention is directed to improving caching of data retrieved by a client browsing the Web by temporarily storing the data in a special cache memory for a user-defined length of time, e.g., two days. As a result, the user may be assured of access to the cached data to guarantee retrieval at a later time even if the user can not then connect to the Web site or if the specific web page of interest is no longer available at that Web site. Deleting stored data after the user-defined deadline efficiently preserves the limited storage capacity of the client device.

In another variation of the present invention, the user may store in special cache certain data from Web sites hyperlinked to a Web site being viewed, without actually viewing the hyperlinked sites.

Further features and advantages of the invention as well as the structure and operation of various embodiments of the invention are described in detail below with reference to the accompanying drawings.

### BRIEF DESCRIPTION OF THE DRAWINGS

FIG. 1 is a schematic diagram of one possible distributed system with various clients and servers connected to the Internet.

FIG. 2 is a block diagram of a client for one embodiment of the present invention.

FIG. 3 is a flow chart of one embodiment of the Quick-Save feature according to the present invention.

FIG. 4 is an illustration of one exemplary graphical user interface (“GUI”) providing user prompts for inputting information that may be used with the Quick-Save feature, according to the present invention.

FIG. 5 is a flow chart of one embodiment of a viewer that displays a list of files stored using the Quick-Save feature of the present invention.

FIG. 6 is a flow chart of one embodiment of the present invention wherein target data in a Web site may be specified for saving prior to accessing the Web site.

### DETAILED DESCRIPTION OF THE INVENTION

A user may desire to access data received from a network (e.g., from a server) at a later time for a variety of reasons. For example, a chef browsing the Web may find a recipe on Wednesday and want to use the recipe the following Friday to prepare dinner. Or a loan officer brokering numerous financial transactions throughout the day may need access to information about daily interest rates published by various banks each morning. A Web page providing such information would be useful for the loan officer. Each morning, the loan officer would log on to the computer, connect to the Internet, and access the Web page to obtain interest rates for the day. If the loan officer's browser cannot access the Web page again later in the day and the browser's cached copy of the Web page has been overwritten by newly cached data, the needed data would not be available. The same problem could affect the chef seeking on Friday the recipe originally viewed on Wednesday. In one embodiment, the present invention allows the chef or the loan officer to specify that the desired data on the Web page be stored for at least several days in a special cache to avoid the problems of overwritten cached data, an inaccessible server, and limited client storage capacity.

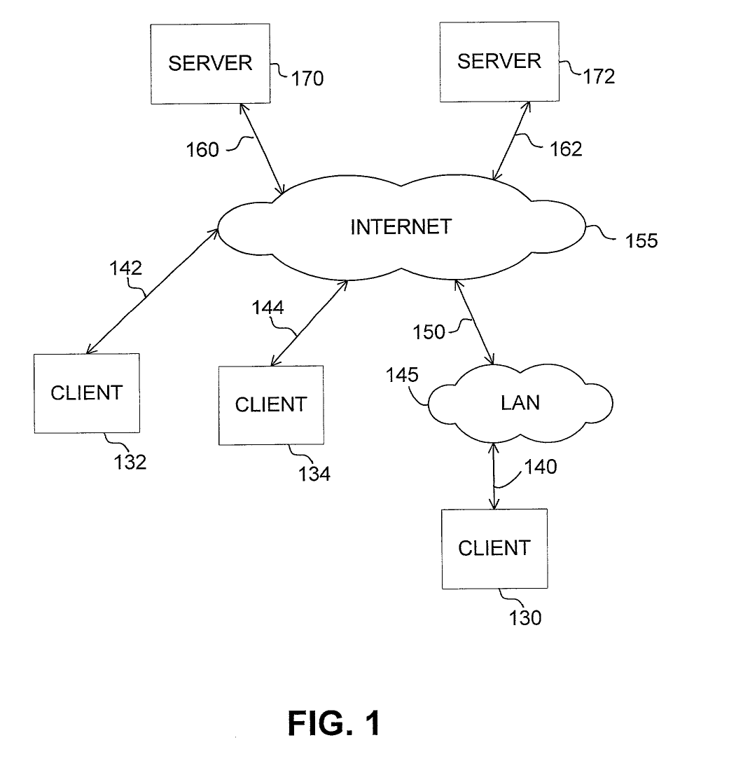

FIG. 1 shows one general network configuration in which the present invention may be useful. The network includes clients, servers, and a LAN connected via the Internet. Client 130 may be a personal computer (“PC”) connected to LAN 145 via network interface 140, and LAN 145 may be connected to Internet 155 via communication channel 150. Client 132 may be, e.g., a mobile telephone connected to Internet 155 via wireless connection 142. Client 134 may be, e.g., a PDA connected to Internet 155 via modem and telephone line 144. Servers 170 and 172 are connected to the Internet via communication channels 160 and 162, respectively.

Servers are information providers. Clients are information receivers. A client may be a PC, a Web device such as a wireless handheld organizer, a Web pad, or a mobile telephone accessing the Internet via the wireless application protocol (“WAP”), or the client may be any other Internet-enabled or networked device or Internet appliance.

The backbone of the network could be, e.g., the Internet, an Intranet, a WAN, or a LAN. Examples of communication channels include a traditional or high-speed telephone line, a satellite system, mobile telephone links, radio or microwave frequency links, infrared interfaces, a digital subscriber line (“DSL”), a cable system, wireless links, fiber optics lines, or any other communication links for accessing the Internet.

Examples of data types that a client may receive from a server include text, graphics, sound, video, applets, Web pages (e.g., in HTML or XML), or any other data type transferable over a distributed system. The data received by the client may be sent by the server without being requested by the client or may be retrieved by a client request.

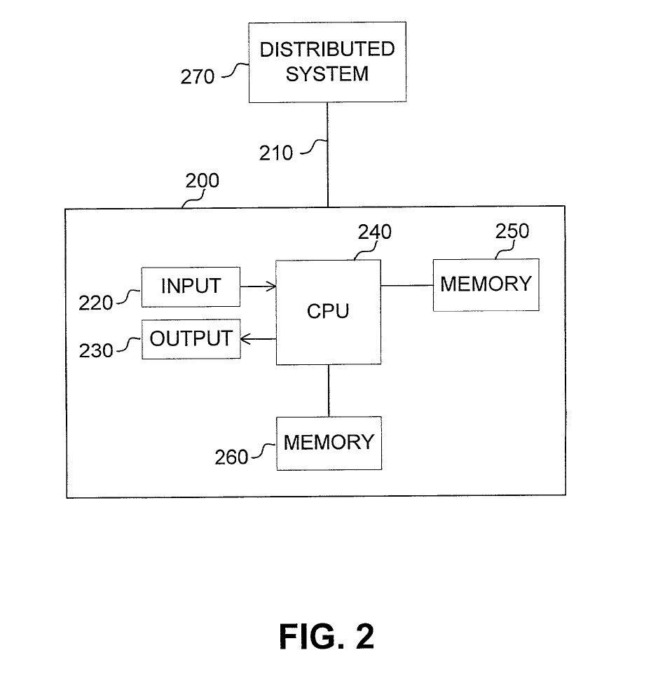

FIG. 2 represents an embodiment of a client such as clients 130, 132, and 134. Client 200 may be connected via communication channel 210 to a distributed system 270 containing, for example, one or more servers. Client 200 includes, e.g., input component 220 and output component 230, each interacting with central processing unit (“CPU”) 240. Input and output components 220 and 230 operate with a user interface that may be textual, graphical, and/or audio. For example, input 220 may be, e.g., a keyboard, keypad, or touch screen, and output 230 may be, e.g., a visual display or speaker. The client may include any suitable operating system and user interface, e.g., Windows (e.g., 95/98, NT, CE), Linux, and/or Palm OS. Modules 250 and 260 represent storage media or memory, e.g., random access memory (“RAM”), Electrically Erasable Programmable Read-Only Memory (“EEPROM”), flash memory, a hard drive, a floppy disk, or a CD.

Cache is a temporary data storage facility in electronic devices for quickly storing and accessing data. Generally, as the client receives portions of data, e.g., a Web page, from the network, this data is automatically stored in cache. If the same data (e.g., the Web page) is requested after the initial viewing, elements of the data that are stored in cache memory may be retrieved from cache rather than from the server.

For example, when a Web page is loaded onto a browser, a comparison is made to Web pages downloaded previously. If the Web page has previously been downloaded, data may be loaded directly from cache instead of from the remote Web site. Caching data may reduce retrieval time, because the data generally can be retrieved more rapidly from cache than from the server. Caching data may also provide access to data that would otherwise be unavailable, e.g., if the server becomes inaccessible.

Cached data may be stored on various media, e.g., a hard drive, a floppy disc, a CD-ROM disc, an optical disc, a “Zip” drive, flash memory, or any other storage device, whether local or on a server different from the original source server. In a distributed system, data from a network server may be cached on a local hard drive, or data from a remote server on a WAN may be cached in a more accessible server, e.g., on the local LAN. Random access memory (“RAM”), EEPROM, and flash memory may also serve to store cached data.

For example, Web browsers such as Netscape Communicator and Microsoft Explorer may use local hard drive space for cache. Cache capacity is generally adjustable by the user in Web browsers. Once cache capacity is reached (i.e., the allocated cache space is filled to capacity), data is deleted from cache on a first-in/first-out basis. Unfortunately, this results in unpredictable deletion of files from cache. The user is not able to save particular user identified data to cache for easy identification and subsequent retrieval. To address this problem, the present invention includes a Quick-Save feature that allows a user to define how long certain data, e.g., a Web page image, will be stored and save it with a user recognized identifier.

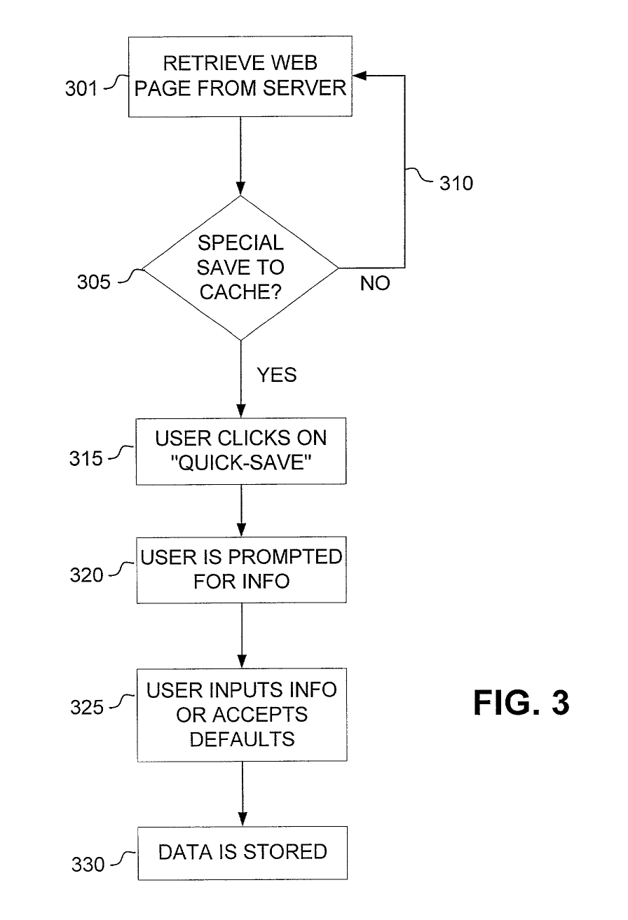

FIG. 3 is a flow chart of one exemplary embodiment of the Quick-Save feature that allows a user to save user specified digital information to memory while specifying a minimum time before deletion. In step 301, the user, for example, retrieves a Web page from an Internet server. At decision tree 305, the user decides whether to save data from the retrieved Web page to the special cache for a user-defined period of time. If the user chooses not to save data from the Web page, the device returns to step 301 via path 310 and allows continued browsing. If the user chooses to save data from the Web page at decision tree 305, the user may activate the Quick-Save feature by, for example, clicking on a Quick-Save icon, as shown in step 315. The device then prompts the user in block 320 for various input, including, for example, a minimum length of time to store the data. The user then inputs the information as desired in step 325, and the Web page is saved to cache in step 330.

The minimum length of time specified to temporarily store the retrieved data may be varied within a very wide range, as needed. For example, the length of time may be 1 second, 1 minute, 1 hour, 1 day, 1 week, or 1 month, or any other time value. The length of time may be specified to any convenient increment, e.g., as a number of hours or days or fractions thereof. The user may also select to store the retrieved data indefinitely, if desired.

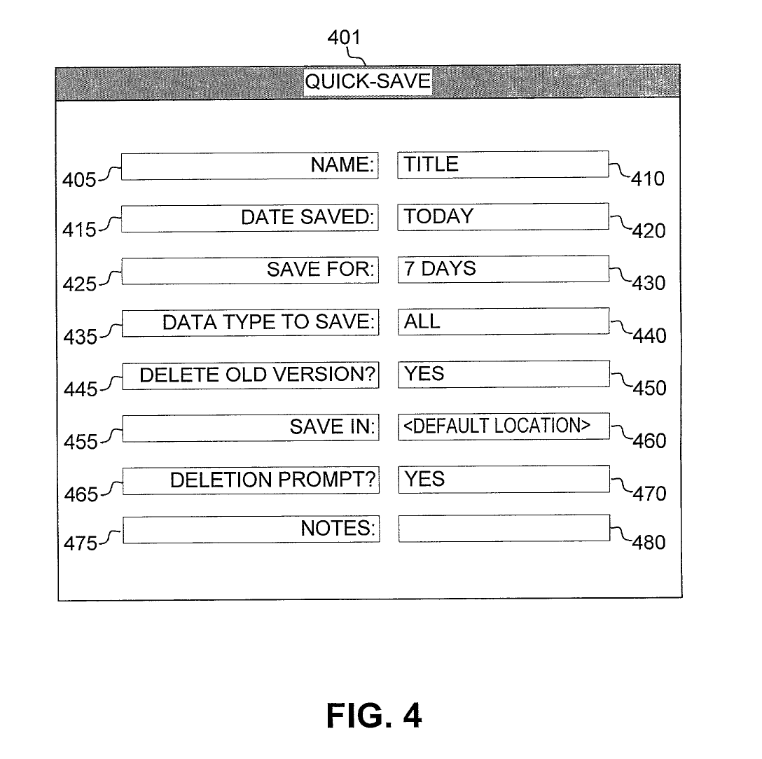

FIG. 4 depicts one exemplary user prompt (which may be a GUI or a part thereof) for inputting information to the Quick-Save function, as represented by step 320 in FIG. 3. After the user activates the Quick-Save by, for example, clicking on a Quick-Save icon, a window 401 may appear prompting the user for various items of information. For example, prompt 405 asks the user for a name, and text box 410 is populated with a default title that may be derived, e.g., from the URL of the viewed Web page (e.g., “filename.htm”), or from data within the Web page, e.g., the HTML title tag or the name of a graphics file (e.g., “filename.jpg”). The user may then overwrite the default title shown in text box 410 if desired. Prompt 415 asks the user for a date, and text box 420 is populated with the current date, which the user can retain or overwrite with a different date. Prompt 425 asks the user for a date after which the data may be deleted. Text box 430 may be blank for entry of a date by the user, or may be populated with a default, e.g., seven (7) days from the current date, as shown in FIG. 4. When the deletion deadline is reached and the stored time entered in text box 430 has expired, the stored data may be deleted immediately or may be subject to first-in/first-out treatment, based on, e.g., the date of initial caching or the date of the deadline. Prompt 435 asks the user to select the type(s) of data to save, e.g., readable text, graphics, sound clips, video clips, JAVA applets or any other software, or any other digitized data. In FIG. 4, text box 440 is shown populated with a default setting of “ALL” data.

In addition, a user later may save partially redundant new information from a Web site, if an older version of the same information has previously been cached. In prompt 445, the user is asked whether to delete any older version of the data or to save the older version. The default “YES” in text box 450 is to delete the old version. In particular circumstances, however, it may be desirable to save the new information separately from the old information. For example, a financial analyst may wish to save financial data collected daily from a Web page for analysis at the end of the week. If so, the financial analyst would enter “NO” in text box 450.

Further, a user may specify the location of the stored information if the client has more than one type of storage device or location. As indicated by prompt 455 in FIG. 4, the user is asked where the data should be stored. The default in text box 460 is set to a default cache memory location.

After the time limit for storage expires, the invention provides various methods for deleting the saved data. For example, the data may be deleted automatically without providing any notice to, or requesting any response from, the user when the time expires. Alternatively, as indicated by prompt 465 and the default in text box 470, notice may be given prior to deletion. In this case, the stored data is deleted only after a user authorizes the deletion in response to a notice. In another embodiment, although a deletion notice may be displayed, a user response would not be required. When the deletion deadline passes, the stored data is deleted automatically. Any of these and other possible deletion options may be the default configuration, and may be changed by the user.

Finally, prompt 475 asks the user for “Notes” to be entered in text box 480. The user may enter text in text box 480 (e.g., “Recipe”) without any particular limitation.

In one embodiment, window 401 may be omitted when quick-saving, and information such as the domain name, the uniform resource locator (“URL”), the title of the Web site, the time of download and/or the save time may be included as defaults.

In one embodiment, the invention provides a method for viewing a list of the stored data. Manually finding an item in conventional browser cache is generally difficult for a user. For example, in the Web browsers Netscape Communicator and Internet Explorer, the user would first have to determine the location of the folder that contains cached files. And neither browser provides a simple way for the user to identify the contents of the cached files. However, the present invention provides simple identification of, and access to, data stored in the cache.

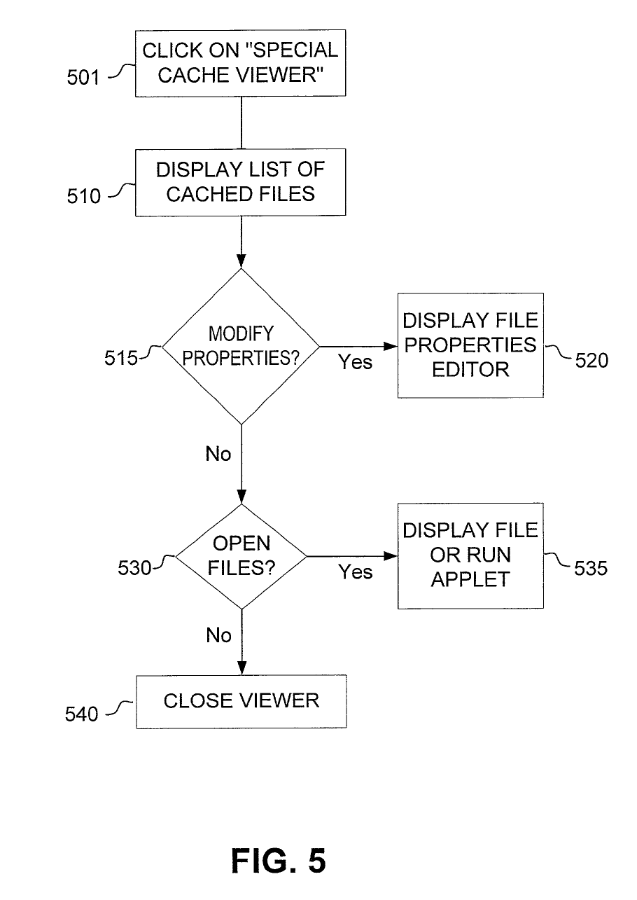

As shown in FIG. 5, in one embodiment the invention may provide a “Special Cache Viewer” icon or menu item. Clicking on the “Special Cache Viewer” icon in step 501 would open a window displaying a list of files in step 510 to allow browsing the files stored in special cache. The window may be configured to display, for example, the contents of any of the text boxes shown in Quick-Save window 401 in FIG. 4. The data may be organized for display in step 510 in a variety of ways depending on user preference, e.g., chronologically, by the source server, by the Internet session, or by the source Web page. While browsing the viewer window, the user may view properties of the stored files, e.g., the file name, URL, domain name, minimum length of time to be stored, and deletion options. In principle, the user can carry out any operations normally available in a window for browsing files and directory trees in an operating system such as Microsoft Windows. If the user chooses in decision step 515 to modify file properties, a properties editor window may be displayed in step 520. Upon reaching decision step 530, the user may choose via step 535 to open a selected file to display the contents or run an applet. Alternatively, the user may close the Special Cache Viewer in step 540. Decision steps 515 and 530 may be arrived at in any order, or simultaneously.

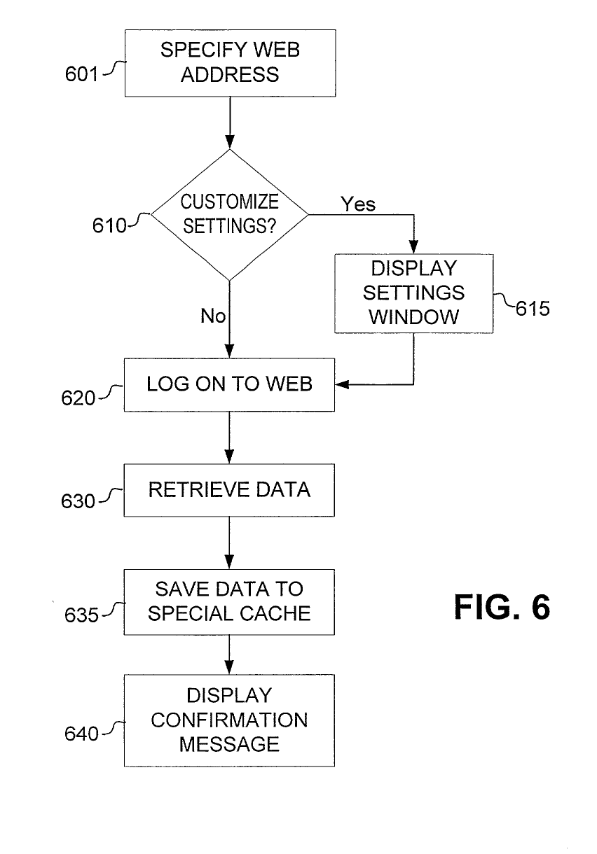

In another embodiment of the invention shown in FIG. 6, the user may configure the client to save data in cache prior to sending a request for that data. For example, the user may specify in step 601 a Web page URL from which to retrieve and store data in cache. The user may then be prompted in decision step 610 to customize settings. If the user chooses to customize settings, the user may do so in step 615 via a Settings window. The user-definable custom settings may include the same user preferences shown in FIG. 4, a subset thereof, or any other settings for modifying. For example, the Quick-Save window 401 (see FIG. 4) may appear in step 615. Alternatively, the user may choose to use default settings and directly access the Web via step 620. The client then connects to the server and receives the data from the server in step 630. The data received from the server may also be displayed on the client device prior to being stored. In any case, the data is then automatically stored in special cache in step 635 without an intermediate instruction from the user. As an option, e.g., set by the user in step 615, the user could be prompted to confirm that the data should be saved. Once the data is saved, a confirmation notice may be displayed on the client device in step 640 to give notice that the requested information has been stored successfully.

In another embodiment of the invention, the user may configure the client to temporarily store for a specified length of time all data retrieved in a particular browsing session or in all future Web browser sessions.

In another embodiment of the invention, the client may be configured to store data from hyperlinks present in a retrieved Web page. The client then automatically accesses each Web site hyperlinked to the retrieved Web site and stores the hyperlinked data. The user may later directly access cached data from the original Web site and from the hyperlinked Web sites. As an option, specific hyperlinks in a retrieved Web page may be selected for downloading.

In another embodiment of the invention, received data (e.g., a Web page) may contain an instruction that the client may read upon receiving the data. The client may respond to the instruction, for example, by alerting the user or by invoking a Quick-Save to store the corresponding data. The instruction may be in the form of a tag (e.g., an HTML tag) recognizable by the client.

While embodiments of the invention have been described above, many more embodiments are within the scope of the invention. The invention is not to be restricted except in light of the claims.

What is claimed is:

1. A method, comprising the steps of:
receiving, with a client, data from a network in a distributed system;
specifying with said client a minimum length of time during which the received data is to be temporarily stored; and
storing temporarily at least a portion of the received data.

2. A method according to claim 1, wherein the received data is stored in a memory space accessible by the client as cache.

3. A method according to claim 2, wherein said received data is stored in a non-volatile memory.

4. A method according to claim 3, wherein the receiving step is via the Internet.

5. A method according to claim 1, wherein the receiving step comprises retrieving data of a Web page.

6. A method according to claim 1, wherein the temporarily stored data comprises data in text, graphics, sound, video, or applet format.

7. A method according to claim 1, further including the step of designating, with said client, that the received data be temporarily stored, wherein the designating step includes a step of presenting a user with a window for user input.

8. A method according to claim 7, wherein the specifying step is carried out by a user in real time.

9. A method according to claim 1, further comprising the step of reading an instruction provided with the received data, wherein the instruction indicates that the received data should be temporarily stored.

10. A method according to claim 1, further comprising the step of deleting the data after the specified minimum length of time.

11. A method according to claim 1, wherein the data is a first Web page containing a hyperlink to a second Web page and the storing step includes storing data of the second Web page.

12. A method, comprising the step of storing Web page data temporarily in a cache for a user specified time period.

13. A method according to claim 12, wherein said data is stored to conserve cache storage space and to ensure that the user may retrieve the data within the user-selected time period.

14. A client, comprising:
a central processing unit;
an input device coupled to said central processing unit;
an output device coupled to said central processing unit; and
a memory space operatively coupled to said central processing unit for storing data,
the client being configured to temporarily store data downloaded from a network for a user specified minimum period of time, after which period of time the stored data is subject to automatic deletion.

15. A client according to claim 14, wherein the memory space is a cache memory space.

16. A client according to claim 14, wherein the memory space is a nonvolatile memory.

17. A client according to claim 14, wherein the client is further configured to respond to a user request to display information about the stored data.

18. A client according to claim 17, wherein the client is further configured to respond to a user request to modify a property of the stored data.

19. A client according to claim 14, wherein the stored data is data from one or more Web site images.

20. A system, comprising:
a client configured to temporarily store data received from a server for a user-specified minimum period of time, to provide user access when said data is not available from said server,
said client being further configured to delete said data after expiration of said user-specified minimum period of time, to recover memory space over time.
